(19) United States
(12) Patent Application Publication
(10) Pub. No.: US 2022/0071260 A1
(43) Pub. Date: Mar. 10, 2022

(54) SOLID SHAPED FOOD CONTAINING NON-DAIRY PROTEIN

(71) Applicant: Ripple Foods, PBC, Berkeley, CA (US)

(72) Inventor: Manoj Kumar, San Ramon, CA (US)

(73) Assignee: Ripple Foods, PBC, Berkeley, CA (US)

(21) Appl. No.: 17/014,026

(22) Filed: Sep. 8, 2020

(51) Int. Cl. A23L 33/185; A23J 3/14; A23J 1/14

(52) U.S. Cl. CPC A23L 33/185; A23V 2002/00; A23J 1/14; A23J 3/14

(57) ABSTRACT

Disclosed are solid, shaped food products containing non-dairy protein. An example of the disclosed food product is a protein bar containing salt-precipitated plant proteins (e.g., from pea) at levels approaching or surpassing 20 or more grams per 60 gram protein bar. The protein bars with this high level of plant-based protein have an appealing appearance, are neutral in flavor with no bitter aftertaste, have good texture and are hypoallergenic or non-allergenic.

### BACKGROUND

Food bars are convenient, prepared and nutritious snacks. One type of food bar includes protein bars that generally contain a higher proportion of protein to carbohydrates and fats than other types of food bars. Protein bars may contain dairy or non-dairy protein. High amounts of some non-dairy, plant-based proteins may not readily form into shaped food products, like bars. Additionally, at high amounts of protein, plant protein-based food bars may not exhibit an appearance, aroma, texture and taste that is desired by the consumer. Furthermore, plant protein based high-protein content bars available today, such as from soybean, tree nuts, and peanuts cause allergies in certain human populations. There is a growing need for high protein content food bars made from nonallergenic or hypoallergenic non-dairy protein.

### SUMMARY

Surprisingly, solid, shaped food products (e.g., food bars) have been made that approach 20 grams of non-dairy protein per 60 grams of food product. These food products have good appearance, aroma, texture and taste. The non-diary protein used in the food products may be obtained from plant sources. Generally, the non-dairy protein is non-allergenic or hypoallergenic. In some examples, the plant source may be pea. In some examples, the non-dairy protein used to make the food products may have an aqueous solubility of less than about 15% (w/w). In some examples, the non-dairy protein may have a solution pH of then than about 7.1. In some examples, the non-dairy protein may have a sodium content of less than about 4500 ppm. In some examples, the non-dairy protein used to make the food products may be salt-precipitated. In some examples, the non-dairy protein may be salt-precipitated at an acidic pH.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

The following U.S. patents and U.S. published patent applications are each incorporated by reference in their entirety into this application:

U.S. Patent Publication No. 2019/0000112 A1 (Ser. No. 16/068,567), published Jan. 3, 2019 and titled, “Product Analogs Or Components Of Such Analogs And Processes For Making Same.”

Other references incorporated by reference may be listed throughout the application.

### BRIEF DESCRIPTION OF THE DRAWINGS

In the accompanying drawings, which are incorporated in and constitute a part of the specification, embodiments of the disclosed inventions are illustrated. It will be appreciated that the embodiments illustrated in the drawings are shown for purposes of illustration and not for limitation. It will be appreciated that changes, modifications and deviations from the embodiments illustrated in the drawings may be made without departing from the spirit and scope of the invention, as disclosed below.

FIGS. 1A, 1B, 1C and 1D illustrate examples of food bars made with different sources and/or amounts of non-dairy protein. The food bars in FIGS. 1A, 1B, 1C and 1D are as described in Example 2 and Tables 3-5 herein.

### DETAILED DESCRIPTION

### Definitions

Unless defined otherwise, all technical and scientific terms used herein have the same meaning as commonly understood by one of ordinary skill in the art to which the present invention pertains. It is to be understood that the terminology used herein is for describing particular embodiments only and is not intended to be limiting. For purposes of interpreting this disclosure, the following description of terms will apply and, where appropriate, a term used in the singular form will also include the plural form and vice versa.

Herein, “adhesiveness” refers to the amount of work necessary to overcome attractive forces of a food to another contact surface. This property may be experienced as gooeyness, stickiness, tackiness, and the like.

Herein, “allergenic” means having the capability to induce allergy. “Non-allergenic” means not capable of causing allergy. “Hypoallergenic” means having a reduced ability to induce allergy. Generally, allergens are allergenic. In some examples, allergens refer to 8 significant food allergens recognized in the United States, including milk (including whey protein and caseinate), eggs, fish, crustacean shellfish, tree nuts, peanuts, wheat and soybeans.

Herein, “aqueous solubility” refers to the maximum amount of a substance (e.g., refined protein preparation) that can be dissolved in water at a given temperature.

Herein, “binder” refers to a substance or substances that are capable of holding a food together. Generally, the binder holds edible particles (e.g., refined protein preparations) together.

Herein, “carbohydrate” includes sugar, starch, oligosaccharides, and cellulose. Herein, carbohydrates are generally from non-animal sources.

Herein, “cellulose” refers to D-glucose units joined by (1→4)-glycosidic bonds.

Herein, “chewiness” as used herein refers to the energy required to chew solid food until it can be swallowed. Chewiness may be determined using texture profile analysis (TPA) testing.

Herein, “cohesiveness” as used herein refers to a measure of the strength of internal bonds making up the body of the product and tendency of product to remain together, and resist breaking into several pieces, during compression. In some examples, this is the extent to which a food deforms when compressed. Generally, cohesiveness is determined using texture profile analysis (TPA) testing.

Herein, “coloring agent” generally refers to a substance that imparts a color to another substance. Herein, coloring agents may be used to impart a desirable color to a food bar.

Herein, “compress” means to make something smaller. One type of food compression uses a vacuum to remove or decrease the amount of air in a food.

Herein, “dairy” refers to food containing or produced from the milk of mammals.

Herein, “edible” means fit to be eaten.

Herein, “emulsifier” refers to substances that stabilize emulsions.

Herein, “exterior layer” refers to a thickness of material on the outside of a food (e.g., a food bar).

Herein, “fat” generally refers to lipids. Herein, fat includes both fats and oils. Herein, generally refer to non-animal fats.

Herein, “flavoring agent” refers to a substance that imparts flavor to another substance. Herein, flavoring agents may be used to make product taste more natural.

Herein, “food” refers to something edible.

Herein, “fracturability” refers to the force at first peak, using texture profile analysis (TPA) testing.

Herein, “hardness” refers to maximum force achieved at the first bite or first compression, using texture profile analysis (TPA) testing.

Herein, “homogeneous” refers to a uniform composition. Herein, although examples of the food bars disclosed may be emulsions and generally are edible particles held together by one or more binders, the food bars may be referred to as homogeneous in the sense that the edible particles in the bar are relatively small. For example, refined protein used in the food bars described here may be in the form of a powder, and when formed into a food bar, particles of the protein are indistinguishable from the rest of the bar by the human eye. In contrast, a food bar containing visible inclusions, like flavored (e.g., chocolate) chips, seeds or nuts, are generally not considered as homogeneous in this disclosure. Therefore, the word “homogeneous” as used herein to refer to the disclosed food products, generally refers to visually homogeneous, using the human eye.

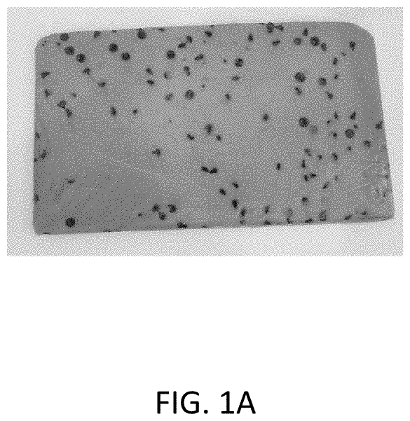

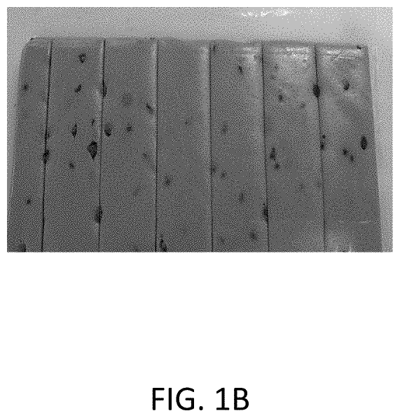

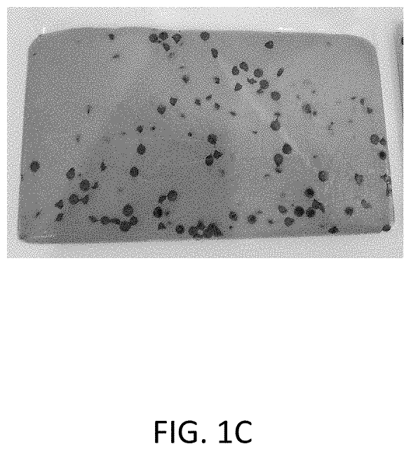

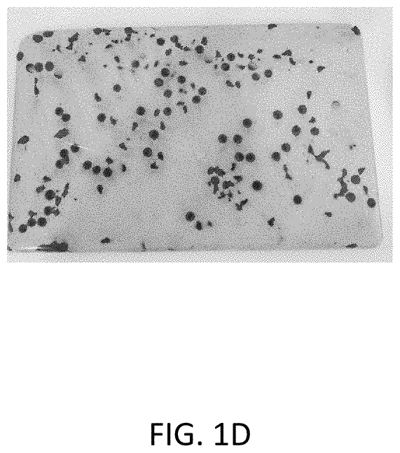

Herein, “inclusions” refer to a body or particle recognizably distinct from the substance in which it is embedded. Herein, inclusions in a food product are generally of a size that are detectable visually, using the human eye. The food bars shown in FIGS. 1A, 1B, 1C and 1D are examples of food bars containing inclusions, as defined herein. The inclusions in those figures are chocolate chips.

Herein, “isolated protein” or “protein isolate” refers to a protein or population of proteins that are substantially isolated from a source. That is, non-protein components have been substantially removed or at least reduced in a preparation of isolated proteins. In some examples, components that may be removed may include insoluble polysaccharide, soluble carbohydrate, ash, other minor constituents and other components. Generally, herein, isolated protein refers to a population of proteins from one or more plant sources. Isolated protein may be in variety of forms, including for example, protein isolate, protein concentrate, protein flour, meal and/or combinations thereof.

Herein, “milk” refers to milk from a mammal (i.e., dairy milk). Milk from a non-animal source is generally referred to as non-dairy milk. Plant-based milk is a type of non-dairy milk.

Herein, “mouthfeel” refers to physical sensations in an individual's mouth caused by food, as opposed to taste of the food. In combination with taste and smell, mouthfeel determines the overall flavor of a food. Mouthfeel is sometimes also called “texture”.

The term “non-dairy” as used here means that the product or formulation has no dairy-based ingredients or less than 0.5% by weight of dairy-based ingredients. The term “substantially non-dairy” as used in the present disclosure means that the product or formulation has less than 5% by weight of dairy-based ingredients.

Herein, “particle,” refers to small localized object or entity.

Herein, “particle size” generally refers to a Dx50 measurement in μm for a population of particles having a distribution of sizes.

Herein, “product” refers to something that is made or processed.

Herein, “protein” refers to a chain or polymer of amino acids, covalently joined by peptide bonds.

Herein, “refined protein” refers to isolated protein that has been processed.

Herein, “resilience” is how well a food fights to regain its original height after compression. Resilience may be determined using texture profile analysis (TPA) testing.

Herein, “salt” refers to a compound made by joining a positively charged acid with a negatively charged base.

Herein, “salt-precipitated protein” refers to refined plant protein made by the process described herein and in U.S. Patent Publication No. 2019/0000112 A1 (Ser. No. 16/068,567), published Jan. 3, 2019 and titled, “Product Analogs Or Components Of Such Analogs And Processes For Making Same.” Protein prepared using a process for salt precipitation that uses, for example, a calcium salt may be called “calcium-precipitated protein.”

Herein, “shape” refers to a defined external form or outline. At least for the food products disclosed herein, common shapes include bars, balls, nuggets, sticks and so forth. A food product that possesses a particular shape may have been given or made into the shaped by a process that may be referred to as “shaping.” In some examples, shaping may include facilitating a liquid or semisolid form of a food to form a solid form.

Herein, “solid” refers to firm and stable in shape; not liquid or fluid.

Herein, “solution pH” refers to pH of water into which an amount of refined protein preparation has been dissolved. Herein, the pH of 10% (w/w) supersaturated solutions of refined protein preparations were determined.

Herein, “springiness” is the degree to which food returns to its original dimensions after being compressed. Springiness may be determined using texture profile analysis (TPA) testing.

Herein, “starch” refers to D-glucose units joined by α(1→4)-glycosidic bonds. Starch contains amylose and amylopectin.

Herein, “sugar” refers to sweet-tasting, soluble carbohydrates. Some example sugars include the disaccharides, sucrose (glucose and fructose) lactose (glucose and galactose) and maltose (two molecules of glucose). Example simple sugars, called monosaccharides, include glucose, fructose, allulose, and galactose. Generally, sugars are sweetening agents.

Herein, “sweetening agent” refers to a substance capable of imparting a taste or flavor characteristic of sugar, honey, and the like, to food. Sweetening agents may include non-caloric sweeteners such as aspartame, saccharin, stevia, monk fruits and protein-based sweeteners. Sweet is a taste sensation that is not bitter, sour or salty.

Herein, “texture” means the appearance, feel and/or consistency of a substance or surface. Regarding food, texture may be defined as the properties of a food that include physical characteristics that come from structural elements of the food which are generally sensed by touch and are related to deformation, disintegration and flow of the food under a force. Some parameters of texture include adhesiveness, chewiness, cohesiveness, fracturability, gumminess, hardness, resilience and springiness. In some examples, some of these parameters may be determined by a Texture Profile Analysis (TPA), using an example instrument called a texture analyzer. Also see “mouthfeel” herein. Related to this, “rheology” is the branch of physics that studies deformation and flow of matter.

Herein, “thickening agent” refers to a substance that increases the viscosity of a liquid. Generally, thickening agents increase viscosity without substantially changing other properties of the liquid. The thickening agents referred to in this application are generally edible thickening agents. In some examples, the thickening agents used herein may dissolve in a liquid as a colloid that forms a cohesive internal structure (e.g., a gel).

Herein, “vegan” means using or containing no animal products.

Herein, “vegetable” means any plant, part of which is used for food or an edible part of a plant. Vegetable may also be defined as any plant part consumed for food that is not a fruit or seed but including mature fruits that are eaten as part of a main meal.

### Solid Shaped Food Products

The food products disclosed herein, that contain non-dairy protein, generally are solid and shaped. In some examples, formulations of the food products are such that they are generally semi-solid in form after mixing the ingredients and become solid after being allowed to stand for a time. In their solid form, the food products disclosed herein have a texture, firmness and hardness that is known in the art for food bars and/or protein bars. In their solid form, the products are said to be “shaped.” For example, the semi-solid form of the formulation may be in the shape of a slab, which is cut into bars after the formulation becomes solid. Other shapes and other processes for forming various shapes are contemplated. Generally, these shapes and processes are known in the art.

Generally, the food products disclosed herein can be described as containing edible particles that are bound together by one or more binders. In some examples, the edible particles include, but may not be limited to, the protein component(s) of the product. In some examples, the protein component may be in the form of granules, powders and the like. In some examples, the binders may be carbohydrates, including starches and/or sugars. In some examples, binders may be lipids, including fats which, herein, include oils. Generally, herein, these components are obtained from non-animal sources.

In some examples, there may be limits on the amount of protein from certain non-dairy sources that can be formed as solid shapes. In some examples, increasing amounts of non-dairy protein may result, not in a solid shape but, instead, in a crumbling mass. In some examples, the crumbling mass result is found using many refined non-dairy protein products, as shown herein.

In some instances, it may be possible to remedy this situation by using increasing amounts or different types of binders. However, this may result in one or more undesired other properties of the food product. In some examples, the resulting food product may have an undesirable calorie content, taste (e.g., too sweet), texture, appearance, as well as other properties.

Herein, we show that certain types of non-dairy protein are better able to form solid, formed food products (e.g., protein bars). In some examples, salt-precipitated plant protein, as described herein and in U.S. Patent Publication No. 2019/0000112 A1 (Ser. No. 16/068,567), published Jan. 3, 2019 and titled, “Product Analogs Or Components Of Such Analogs And Processes For Making Same” may form solid-shaped food, similar to other types of protein bars, with higher protein content than possible with other refined proteins.

### Ingredients

In some examples, the ingredients used in the food bars disclosed herein may include various carbohydrates, non-dairy and/or plant-based protein, plant-based fats, including plant based oils, emulsifiers, sweetening agents, salt, flavoring agents, binding agents, thickening agents, coloring agents, water, vitamins and/or other nutritional supplements, enzymes, and other ingredients.

Generally, the amount of an ingredient or ingredients is given in “percent by weight” or “weight percent” of the composition. The weight percent of various ingredients may refer to the amount of the ingredient in the formulation for making a solid, shaped food product and/or in the solid, shaped product itself, as specified. Generally, the ingredients described in the sections below are grouped by chemical category (e.g., carbohydrate, protein, fat). In some examples, however, ingredients are grouped into functional categories (e.g., emulsifier, flavoring agent, sweetening agent). In some examples, an ingredient grouped in a chemical category may have one or more activities of one or more of the functional categories (e.g., some carbohydrate starches may have emulsifier activity), even though the ingredient is not listed as part of the functional category. In some examples, an ingredient grouped in a functional category may contain chemical substances that could be grouped into one or more chemical categories. In some examples, an ingredient grouped in a chemical category may contain substances from one or more other chemical categories. In some examples, an ingredient grouped in a functional category may have at least some activity that could be grouped in other functional categories. Grouping an ingredient in one category may not preclude that it may have chemical composition and/or activity that could be classified in a different category.

In some examples, the food products disclosed herein may include about or include no more than about 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295 or 300 calories per 60 grams of the food product.

### Carbohydrates

Herein, “carbohydrate” includes sugars, starch and cellulose. Carbohydrates may be monosaccharides, disaccharides, oligosaccharides or polysaccharides. Sugars may include polyols/sugar alcohols. Carbohydrates may be digestible or may be indigestible or poorly digestible. Herein, carbohydrates are generally from non-animal sources. In some examples, the carbohydrates used in the food products disclosed herein may be from plant sources. Carbohydrates may function as sweeteners, binders, fiber sources, moisture-holders, texture-modifiers, and may serve other functions in the disclosed food products. In some examples, a single source of carbohydrate may be used in the disclosed food products. In some examples, 2, 3, 4, 5, 6, 7, 8, 9 or 10 different sources and/or types of carbohydrates may be used in the disclosed food products.

In some examples, the carbohydrates used herein may be from any plant source. In some examples, the carbohydrates used herein may be from arracacha, arrowroot, canna, cassava (e.g., tapioca), chickpeas, corn, favas, lentils, maize, mung beans, peas, maize, millet, nuts, potatoes, rice, sago, sorghum, sweet potatoes, taro root, rye, yams, waxy maize, soy and others.

In some examples, the carbohydrates used herein may specifically exclude one or more plant sources. In some examples, the carbohydrates used in the food products disclosed herein may exclude one or more of carbohydrates from arracacha, arrowroot, canna, cassava (e.g., tapioca), chickpeas, corn, favas, lentils, maize, mung beans, peas, maize, millet, potatoes, rice, sago, sorghum, sweet potatoes, taro root, rye, yams, waxy maize, soy and others.

Carbohydrates may be in solid or liquid form. Carbohydrates may be water soluble or non-water soluble. Carbohydrates may be in the form of a powder. Carbohydrates may be in the form of a syrup. Carbohydrates may be in other forms.

Example carbohydrates used in the disclosed food products may include corn syrup, corn fiber, high fructose corn syrup, tapioca syrup, crystalline fructose, tagatose, sucrose, lactose, maltose, galactose, xylose, dextrose, cyclodextrins, trehalose, raffinose, stachyose, fructooligosaccharide, maltodextrins, starches, pectins, gums, carrageenan, inulin, or cellulose based compound, or various sugar alcohols, including sorbitol, mannitol, maltitol, xylitol, lactitol, isomalt, erythritol or others.

Example carbohydrates used in the disclosed food products may include glucose, sucrose, fructose, dextrose, lactose and maltose. Carbohydrate sucrose, cocoa butter, high-fructose corn syrup, peanut butter, nuts, maltodextrins, isomalitulose, maltitol syrups, sorbitol syrups and mixtures thereof. Example carbohydrates used in the disclosed food products may include polydextrose, xylose, xylitol, sorbitol, cyclodextrins, trehalose, raffinose, stachyose, fructooligosaccharide, maltose, pectins, gums, carrageenan, inulin, hydrogenated indigestible dextrins, hydrogenated starch hydrolysates, highly branched maltodextrins and cellulose.

The carbohydrate preparations used herein as ingredients of the food products disclosed herein may contain at least 5, 10, 15, 20, 25, 30, 35, 40, 45, 50, 55, 60, 65, 70, 75, 76, 77, 78, 79, 80, 81, 82, 83, 84, 85, 86, 87, 88, 89, 90, 91, 92, 93, 94, 95, 96, 97, 98 or 99% carbohydrate, as defined above. The carbohydrate ingredients may contain other components like, for example, ash, calcium, fat, heavy metals, iron, magnesium, potassium, protein, sodium, vitamins and others.

In some examples, the carbohydrates used herein may be modified. Starch, for example, may be modified by physical and/or chemical means. Some examples of physical modification may include superheating, dry heating, osmotic pressure treatment, multiple deep freezing and thawing, instantaneous controlled pressure-drop process, stirring ball milling, vacuum ball milling, pulsed electric fields treatment, corona electrical discharges and others. Chemical modification may include adding new or modifying existing moieties in the carbohydrate. In some examples, the modifications may be introduced at hydroxyl groups of carbohydrates. Modifications may involve chemical derivatization, like etherification, esterification, acetylation, cationization, oxidation, hydrolysis, cross-linking and others.

Modified starch, for example, may have enhanced properties. Example enhanced properties may include enhancements in color, dispersion, emulsion stabilization and/or encapsulation, flavor, gelling, melting, solubility, texture, thermal stability, viscosity and others.

The starch used in the food products may be a single type of starch (e.g., from a particular plant, or a particular commercial source) or may be combinations of multiple types of starch, for example, 2, 3, 4, 5, 6, 7, 8, 9, 10 or more types of starch. In some examples, one or more specific starches may be excluded.

In some examples, carbohydrates may be included in the food product formulations and/or final food products at amounts that are about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84 or 85 percent by weight of the food product.

In some examples, carbohydrates may be included in the food product formulations and/or final food products at amounts that are no more than about 20, 25, 30, 31, 32, 33, 34, 35, 36, 37, 38, 39, 40, 41, 42, 43, 44, 45, 46, 47, 48, 49 or 50 percent by weight of the food product.

In some examples, carbohydrates may be included in the food product formulations and/or final food products at amounts that are about or between about 1-80 percent by weight. In some examples, starch may be included at amounts about or between about 1-40, 2-60, 2-55, 2-50, 2-45, 2-40, 2-38, 2-35, 3-30, 3-36, 4-60, 4-55, 4-50, 4-45, 4-40, 4-35, 4-30, 4-25, 5-32, 6-60, 6-55, 6-50, 6-45, 6-40, 6-35, 6-30, 7-28, 8-26, 8-24, 8-20, 8-16, 9-30, 9-28, 9-24, 10-35, 10-30, 10-28, 10-25, 10-22, 10-20, 10-14, 11-35, 11-30, 11-25, 11-20, 11-15, 12-30, 12-25, 12-20, 12-18, 13-45, 13-35, 13-30, 13-25, 13-20, 14-30, 14-28, 14-26, 14-24, 14-22, 15-30, 15-25, 15-20, 16-25, 17-25, 17-20, 18-25, 18-24, 20-25 percent by weight and others.

In some examples, maltodextrin may be used as an ingredient of the food products disclosed here. In some examples, maltodextrin may be used at amounts about or between about 1-5 percent by weight.

### Isolated and Refined Protein

Herein, “protein” refers to a chain or polymer of amino acids, covalently joined by peptide bonds. Herein, proteins are generally non-dairy proteins. Generally, proteins used in the food products disclosed herein contain non-dairy proteins from plants. Proteins from any plant may be used in the food formulations and products described herein. Various plant proteins used may be from almond, barley, canola, carrot, cabbage, celery, cereal, chickpea, coconut, emmer, fennel, flax, fava bean, garbanzo bean, lettuce, lupin seeds, melon, mushroom, navy bean, oat, pea, pear, potato, quinoa, rapeseed, rice, sesame, soybean, sunflower, wheat, white bean, yellow pea and others.

In some examples, one or more specific plant proteins or plant protein sources may be excluded from the food products disclosed herein. In various examples, proteins from almond, barley, canola, carrot, cabbage, celery, cereal, chickpea, coconut, emmer, fennel, flax, fava bean, garbanzo bean, lettuce, lupin seeds, melon, mushroom, navy bean, oat, pea, pear, potato, quinoa, rapeseed, rice, sesame, soybean, sunflower, wheat, white bean, yellow pea and others may be specifically excluded.

Plant proteins may be from one type of plant or from multiple plants. Other suitable plant protein isolates are also acceptable. In some examples, the plant protein component may include gluten as part of the plant protein. In some examples, the food products disclosed here do not contain gluten.

In some examples, food products disclosed herein may contain proteins from only one plant protein source. In some examples, the food bars may contain proteins from 2, 3, 4, 5, 6, 7, 8, 9 or 10 plant protein sources.

In some examples, specific sources of plant proteins may be excluded from the plant proteins used in the food bars disclosed herein. In some examples, plant proteins from one, or from 2, 3, 4, 5, 6, 7, 8, 9, 10 sources may be excluded from the food bars disclosed herein. In some examples, plant proteins from one, or more or all of the following plants may be specifically excluded: almond, barley, canola, carrot, cabbage, celery, cereal, chickpea, coconut, emmer, fennel, flax, fava bean, garbanzo bean, lettuce, lupin seeds, melon, mushroom, navy bean, oat, pea, pear, potato, quinoa, rapeseed, rice, sesame, soybean, sunflower, wheat and white bean.

In some such examples, the protein may be from a legume. Generally, any edible legume may be used as a source of protein. In some examples, proteins from one or more specific legumes may be excluded.

In some examples, legumes may include aburaage, adzuki beans, alfalfa, anasazi beans, asparagus beans, awase miso, azufrado beans, barley miso, bayo beans, beans, bean curd skin, black adzuki beans, black beans, black chickpeas, black kidney beans, black nightfall beans, black valentines beans, black lentils, black soybeans, black turtle beans, bolita beans, bonavist beans, borlotti beans, bountiful beans, brown lentils, brown speckled cow beans, broad beans, butter beans, calypso beans, canary beans, cannellini beans, carob, chickpeas, christmas lima beans, climbing French beans, clover, cowpeas, crab eye beans, dark red kidney beans, dwarf peas, English peas, European soldier beans, eye of goat beans, fava beans, fayot, flageolet beans, garden peas, great norther beans, hyacinth bean, inariage, Jackson wonder lima bean, kidney bean, kinugoshi, koya-dofu, lablab, lentils, licorice, lima beans, lingot beans, lupins, lupin seeds, Maine yellow eye beans, mayocoba beans, mesquite, molasses face beans, mortgage lifter beans, mung beans, natto, navy beans, okara, ocra beans, otebo beans, peanuts, peas, pigeon peas, pink beans, pink lentils, pinto beans, potato beans, puy lentils, rattlesnake beans, red beans, red eye beans, red lentils, red miso, roman beans, salugia beans, scarlet runner beans, shelling peas, small red beans, small white beans, snow peas, sourthern peas, soybeans, Steuben yellow beans, sugar snap peas, tamarind, tempeh, tongue of fire beans, trout beans, turtle beans, usuage, vallarta beans, vaquero beans, winged beans, yellow lentils, yellow miso, yin yang beans, yuba yellow indian women beans, and others.

In some examples, plant proteins from one, or more or all of the following legumes may be specifically excluded from the food bars disclosed herein: aburaage, adzuki beans, alfalfa, anasazi beans, asparagus beans, awase miso, azufrado beans, barley miso, bayo beans, beans, bean curd skin, black adzuki beans, black beans, black chickpeas, black kidney beans, black nightfall beans, black valentines beans, black lentils, black soybeans, black turtle beans, bolita beans, bonavist beans, borlotti beans, bountiful beans, brown lentils, brown speckled cow beans, broad beans, butter beans, calypso beans, canary beans, cannellini beans, carob, chickpeas, christmas lima beans, climbing French beans, clover, cowpeas, crab eye beans, dark red kidney beans, dwarf peas, English peas, European soldier beans, eye of goat beans, fava beans, fayot, flageolet beans, garden peas, great norther beans, hyacinth bean, inariage, Jackson wonder lima bean, kidney bean, kinugoshi, koya-dofu, lablab, lentils, licorice, lima beans, lingot beans, lupins, lupin seeds, Maine yellow eye beans, mayocoba beans, mesquite, molasses face beans, mortgage lifter beans, mung beans, natto, navy beans, okara, ocra beans, otebo beans, peanuts, peas, pigeon peas, pink beans, pink lentils, pinto beans, potato beans, puy lentils, rattlesnake beans, red beans, red eye beans, red lentils, red miso, roman beans, salugia beans, scarlet runner beans, shelling peas, small red beans, small white beans, snow peas, sourthern peas, soybeans, Steuben yellow beans, sugar snap peas, tamarind, tempeh, tongue of fire beans, trout beans, turtle beans, usuage, vallarta beans, vaquero beans, winged beans, yellow lentils, yellow miso, yin yang beans and yuba yellow indian women beans

In some examples, the protein may be lupine protein, including pea or yellow pea. The pea may be whole pea or a component of pea, standard pea (i.e., non-genetically modified pea), commoditized pea, genetically modified pea, or combinations thereof. In some examples, the pea may be Pisum sativum.

In some examples, the protein may be hypoallergenic or non-allergenic protein. Of note is that pea protein is not among the 8 significant food allergens recognized in the United States, which include milk, eggs, fish, crustacean shellfish, tree nuts, peanuts, wheat and soybeans. Pea protein is not among the 14 significant food allergens recognized in Europe. One example hypoallergenic/non-allergenic protein, therefore, includes protein sourced from pea. In some examples, the hypoallergenic or non-allergenic protein may be sourced from hemp, chia, spirulina, quinoa, teff, amaranth, buckwheat and millet. Other hypoallergenic/non-allergenic plant proteins are known in the art.

In some examples, the food bars disclosed herein may contain no other protein or no other plant protein, except protein from peas or protein from yellow peas. In some examples, the food bars disclosed herein may contain no other protein or no other plant protein, except protein from Pisum sativum.

In some examples, the protein may be from soy. The soy may be whole soy or a component of soy, standard soy (i.e., non-genetically modified soy), commoditized soy, genetically modified soy, or combinations thereof. In some examples, soy protein may be specifically excluded from the food products disclosed here.

In some examples, the protein may be from chickpea. The chickpea may be whole chickpea or a component of chickpea, standard chickpea (i.e., non-genetically modified chickpea), commoditized chickpea, genetically modified chickpea, or combinations thereof. In some examples, chickpea protein may be specifically excluded from the food products disclosed here.

In some examples, the protein may be from one or more microbes, including yeast. In some examples, protein from one or more specific microbes may be specifically excluded from the food products disclosed here.

Plant protein (e.g., isolated protein) may contain components that negatively affect taste, texture and/or other properties of food bars made using the protein. In some examples, the isolated protein preparation may be processed for various purposes, such as to remove components like aroma agents, coloring agents, flavoring agents and other components. In some examples, the protein may be extracted in a solvent to remove lipids and/or heat treated to remove volatiles. Examples of treatments to obtain refined protein are described in the next section of this application.

In some examples, the refined protein may have an aqueous solubility of about 50, 45, 40, 35, 30, 25, 20, 15, 10, 9, 8, 7, 6, 5, 4, 3, 2 or 1 percent (w/w). In some examples, the refined protein may have an aqueous solubility of less than about 15, 14, 13, 12, 11, 10, 9, 8, 7, 6, 5, 4, 3, 2 or 1 percent (w/w).

In some examples, the refined protein may have a solution pH of about or less than about 8.0, 7.9, 7.8, 7.7, 7.6, 7.5, 7.4, 7.3, 7.2, 7.1, 7.0, 6.9, 6.8, 6.7, 6.6, 6.5, 6.4, 6.3, 6.2, 6.1, 6.0, 5.9, 5.8, 5.7, 5.6, 5.5, 5.4, 5.3, 5.2, 5.1, 5.0, 4.9. 4.8, 4.7, 4.6, 4.5, 4.4, 4.3, 4.2, 4.1, 4.0, 3.9 or 3.8.

In some examples, the refined protein may have a sodium content of about or less than about 8000, 7500, 7000, 6500, 6000, 5500, 5000, 4900, 4800, 4700, 4600, 4500, 4400, 4300, 4200, 4100, 4000, 3900, 3800, 3700, 3600, 3500, 3400, 3300, 3200, 3100, 3000, 2900, 2800, 2700, 2600, 2500, 2400, 2300, 2200, 2100, 2000, 1900, 1800, 11700, 1600, 1500, 1400, 1300, 1200, 1100, 1000, 950, 940, 930, 920, 910, 900, 890, 880, 870, 860, 850, 840, 830, 820, 810, 800, 790, 780, 770, 760, 750, 740, 730, 720, 710, 700, 690, 680, 670, 660, 650, 640, 630, 620, 610, 600, 590, 580, 570, 560, 550, 540, 530, 520, 510, 500, 490, 480, 470, 460, 450, 440, 430, 420, 410, 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 90, 80, 70, 60, 50, 40, 30, 20 or 10 parts per million (ppm).

The refined protein preparation may have various forms, including, but not limited to concentrate, flour, isolate, meal, paste, powder and others. The protein may be native, denatured or renatured; dried, spray dried, or not dried protein; enzymatically treated or untreated protein; and combinations thereof. The protein may consist of particles of one or more sizes and may be pure or mixed with other components (e.g., other plant source components).

In some examples, proteins processed by specific methods may be excluded from the food products disclosed herein. In some examples, proteins having specific forms (e.g., concentrate, flour, isolate, meal, paste, powder) may be excluded from the food products disclosed herein. In some examples, proteins that are denatured, renatured; dried, spray dried; enzymatically treated; of specific sizes; and/or mixed with other components, may be specifically excluded from the food products disclosed herein.

In some examples, the processed or refined protein may contain at least 10, 20, 30, 40, 50, 60, 70, 80 or 90 percent by weight of protein. The processed or refined protein may contain a percent by weight of protein of between 10-30, 10-20, 12-16, 20-99, 20-60, 25-95, 30-90, 30-50, 40-99, 40-95, 40-90, 40-85, 40-80, 40-75, 50-99, 50-95, 50-90, 50-85, 50-80, 60-99, 60-95, 60-90, 60-85, 60-80, 60-75, 65-99, 65-95, 65-90, 65-85, 65-80, 70-99, 70-95, 70-90, 70-85, 70-80, 75-99, 75-95, 75-90, 75-85, 75-80 and others.

In some examples, the processed/refined protein may contain carbohydrates and/or fat. In some examples, the processed/refined protein may contain calcium, phosphorous, potassium, sodium, and other cations. In some examples, the processed/refined protein may contain ash.

In some examples, the food products disclosed herein may specifically exclude one or more cations and/or ash.

In some examples, the refined protein may have a carbohydrate content of between 0-50% by weight. In some examples, the refined protein may have a carbohydrate content of at least 0% by weight. In certain examples, the refined protein may have a carbohydrate content of less than 25% by weight.

In some examples, the refined protein may have a starch content of between 0-10% by weight. In some examples, the refined protein may have a starch content of at least 3% by weight. In some examples, the refined protein may have a starch content of less than 9% by weight.

In some examples, the refined protein may have a fat content of between 1-30% by weight. In some examples, the refined protein may have a fat content of at least 2% by weight. In some examples, the refined protein may have a fat content of less than 25% by weight.

In some examples, the refined protein may have a calcium content of between 0-5% by weight. In some examples, the calcium content may be between about 0.1 and 2% by weight.

In some examples, the refined protein may have a phosphorus content of between 0-6% by weight. In some examples, the phosphorus content may be at least 0.1% by weight. In some examples, the refined protein may have a phosphorus content of less than 4% by weight.

In some examples, the refined protein may have a sodium and/or potassium content of less than 0.5% by weight.

In some examples, the refined protein may have an ash content of between 0-20% by weight. In some examples, the refined protein may have an ash content of at least 1% by weight.

In some examples, the refined protein may be in the form of granules. In some examples, the refined protein may be in the form of a powder. In some examples, the refined protein may be in the form of a granulated powder. In some examples, the refined protein may be a flour. In some examples, the size of particles or the mean size of particles in these forms of refined protein may be between 1 and 1000 μm, 10 and 500 μm, 50 and 350 μm, 70 and 250 μm or 100 and 150 μm. In some examples, the mean size of particles in a distribution of the particles may be about 0.1, 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 μm in size. In some examples, at least 10, 20, 30, 40, 50, 60, 70, 80, 90 or 95% of the particles these forms of refined protein may be about 0.1, 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 μm in size.

In some examples, a particle size distribution for the protein particles may be Dx50 of about or less than about 200, 190, 180, 170, 160, 150, 140, 130, 120, 110, 100, 90, 80, 70, 60, 50, 40, 30, 20 or 10 μm.

In some examples, adsorption of water, the amount of water adsorbed, the rate at which water is adsorbed, and the like, may be affected by the size of the protein particles. In some examples, things like the amount and/or rate of water adsorption may be related to or proportional to the surface area, volume, surface area per unit volume, and the like, of the protein particles (e.g., granules, powder, granulated powder). In some examples, this may not be the case.

The protein preparations used herein may have some binder activity. The protein preparations used herein may have some emulsifier activity.

### Processes for Preparing Refined Plant Protein

Various methods may be used for obtaining refined protein components from non-animal natural protein sources. The refined protein components may be used in the food products disclosed herein. However, isolated protein or non-refined protein components may also be used, exclusively or in combination with refined protein components.

Generally, the methods described below may remove or substantially remove components that may affect flavor, aroma, color and so on, from protein preparations, and thus make the refined protein preparations more suitable for use in the disclosed food bars. Removal of such agents may also increase the shelf life of food bars comprising such refined protein components.

In some examples, methods for obtaining refined protein components from non-animal natural sources may comprise one or more of the following steps, in or out of order:

a) obtaining a protein preparation from a non-animal natural source;

b) washing the protein preparation at a wash pH;

c) extracting the protein preparation at an extraction pH to obtain an aqueous protein solution;

d) separating the aqueous protein solution from non-aqueous components;

e) adding salt;

f) precipitating the protein from the aqueous protein solution at a precipitation pH to obtain a protein precipitate;

g) separating the protein precipitate from non-precipitated components; and

h) washing the protein precipitate to obtain a refined protein component (e.g., salt-precipitated protein).

Generally, it is at least steps (e) and (f) above that are used to prepare what is called herein as “salt-precipitated protein.” Additional steps may also be included in the process.

Washing the refined protein preparation may utilize various methods, including single wash, multiple washes, and/or counter-current washes.

The wash and extraction pH may be a pH that is suitable for washing and solubilizing proteins in a protein preparation. The wash pH and extraction pH may be the same, may be different or may be opposite (e.g., acidic vs. basic) one another. A suitable wash and extraction pH may be determined by testing various pH conditions, and identifying the pH condition at which the most optimal yield and quality (judged by, for example by one or more of the following: flavor, odor, color, nitrogen content, calcium content, heavy metal content, emulsification activity, molecular weight distribution, and thermal properties of the protein component obtained) of the refined protein component is obtained. In some examples, the wash and extraction pH are alkaline pH. In some such examples, the alkaline pH is at least 7.1, at least 8, at least 9, at least 10, at least 11, at least 12, between 7.1 and 10, between 8 and 10, between 9 and 10, or between 8 and 9. In some such examples, the alkaline pH is 8.5. In some examples, the wash and extraction pH are acidic pH. In some such examples, the acidic pH is less than 7, less than 6.95, less than 6.5, less than 5, less than 4, less than 3, between 2 and 6.95, between 3 and 6, or between 3 and 5. The extraction pH may be adjusted using a pH adjusting agent. In some examples, the pH adjusting agent is a food grade basic pH adjusting agent. In other examples, the pH adjusting agent is a food grade acidic pH adjusting agents. Examples of suitable acidic pH adjusting agents include, but are not limited to, phosphoric acid, acetic acid, hydrochloric acid, citric acid, succinic acid, and combinations thereof. Examples of suitable basic pH adjusting agents include, but are not limited to, potassium bicarbonate, sodium bicarbonate, sodium hydroxide, potassium hydroxide, calcium hydroxide, ethanolamine, calcium bicarbonate, calcium hydroxide, ferrous hydroxide, lime, calcium carbonate, trisodium phosphate, and combinations thereof. It may be useful to obtain substantially as much extracted protein as is practicable so as to provide an overall high product yield. The yield of protein in the aqueous protein solution may vary widely, wherein typical yields range from 1% to 90%. The aqueous protein solution typically has a protein concentration of between 1 g/L and 300 g/L. The molecular weight distribution of the proteins comprised in the aqueous protein solution may vary widely.

Separating the aqueous protein solution from non-aqueous components may be accomplished by various methods, including but not limited to, centrifugation followed by decanting of the supernatant above the pellet, or centrifugation in a decanter centrifuge. The centrifugation may be followed by disc centrifugation and/or filtration (e.g., using activated carbon) to remove residual protein source material and/or other impurities. The separation step may be conducted at various temperatures within the range of 1° C. to 100° C. For example, the separation step may be conducted between 10° C. and 80° C., between 15° C. and 70° C., between 20° C. and 60° C., or between 25° C. and 45° C. The non-aqueous components may be re-extracted with fresh solute at the extraction pH, and the protein obtained upon clarification combined with the initial protein solution for further processing as described herein. The separated aqueous protein solution may be diluted or concentrated prior to further processing. Dilution is usually affected using water, although other diluents may be used. Concentration may be affected by membrane-based methods. In some examples, the diluted or concentrated aqueous protein solution comprises between 1 g/L and 300 g/L, between 5 g/L and 250 g/L, between 10 g/L and 200 g/L, between 15 g/L and 150 g/L, between 20 g/L and 100 g/L, or between 30 g/L and 70 g/L by weight of protein.

The protein in the aqueous protein solution may be optionally concentrated and/or separated from small, soluble molecules. Suitable methods for concentrating include, but are not limited to, diafiltration or hydrocyclonation. Suitable methods for separation from small, soluble molecules include, but are not limited to, diafiltration.

Salt precipitation may be accomplished using various suitable salts and precipitation pHs. Suitable salts, salt concentrations, polysaccharides, polysaccharide concentrations, and precipitation pHs may be determined by testing various conditions and identifying the salt and pH and polysaccharide conditions which obtain the most colorless and/or flavorless protein precipitates at the most optimal yield and quality (judged by, for example, by one or more of the following: flavor, odor, color, nitrogen content, calcium content, heavy metal content, emulsification activity, molecular weight distribution, and thermal properties of the protein component obtained). In some examples, salt precipitation occurs with calcium dichloride at a concentration of between 5 mM and 1,000 mM. Other examples of suitable salts include, but are not limited to, other alkaline earth metal or divalent salts (e.g., magnesium chloride, sodium chloride, calcium permanganate, and calcium nitrate). Typically, the precipitation pH is opposite the extraction pH (i.e., when the extraction pH is in the basic range, the precipitation pH is most suitable in the acidic range, and vice versa). In some examples, the precipitation pH is an acidic pH. In some such examples, the acidic pH is less than 7.1, less than 6, less than 5, less than 4, less than 3, less than 2, between 6.9 and 2, between 6 and 3, between 6 and 5, or between 5 and 4. In some such examples, the acidic pH is 5.25. The precipitation pH may be adjusted using a pH adjusting agent. In some examples, the pH adjusting agent is a food grade acidic pH adjusting agent. In other examples, the pH adjusting agent is a food grade basic pH adjusting agent.

Separating the protein precipitate from non-precipitated components may occur by one or more of the methods disclosed herein.

Washing of the protein precipitate may occur by various methods. In some examples, the washing is carried out at the precipitation pH.

The protein precipitate may optionally be suspended. In some examples, the suspending is carried out at the extraction pH, for example, in the presence of a chelator to remove calcium ions. If the suspended protein preparation is not transparent it may be clarified by various convenient procedures such as filtration or centrifugation.

The pH of the suspended color-neutral refined protein component may be adjusted to a pH of between 1 and 14, between 2 and 12, between 4 and 10, or between 5 and 7, by the addition of a food grade basic pH adjusting agent, including, for example, sodium hydroxide, or food grade acidic pH adjusting agent, including, for example, hydrochloric acid or phosphoric acid.

The refined protein component may be dried. Drying may be performed in a suitable way, including, but not limited to, spray drying, dry mixing, agglomerating, freeze drying, microwave drying, drying with ethanol, evaporation, refractory window dehydration or combinations thereof.

Other optional steps in the exemplary methods are heating steps aimed at removing heat-labile contaminants and/or microbial contaminations, and additional filtering (e.g., carbon filtering) steps aimed at removing additional odor, flavor, and/or color compounds. In some examples, such additional filtering is carried out immediately after extracting the protein preparation or after separating the aqueous protein solution from the non-aqueous components.

### Amounts of Protein in Food Bar Formulations and Products

In some examples, the disclosed food products containing non-dairy protein are made with unrefined/non-refined proteins from plants. In some examples, the food products are made with processed/refined proteins from plants (e.g., salt-precipitated protein).

In some examples, protein may be included in the disclosed food products at amounts that are about or at least about 10, 11, 12, 13, 14, 15, 16, 17, 18, 19, 20, 21, 22, 23, 24, 25, 26, 27, 28, 29, 30, 30 or more grams per 60 grams of the food product. In some examples, protein may be included in the disclosed food products at amounts that are about or at least about 16, 16.5, 17, 17.5, 18, 18.5, 19, 19.5, 20, 20.5, 21, 21.5, 22, 22.5, 23 or 23.5 or more grams per 60 grams of the food product

In some examples, protein may be included in the food bar formulations and/or final food bar product at amounts that are about or between about 0-50 percent by weight. In some examples, protein may be included at amounts about or between about 15-25, 16-24, 17-23, 18-22, 19-21, 16-26. 17-25, 18-24, 19-23, 20-22, 17-27, 18-26, 19-25, 20-24, 21-23, 18-28, 19-27, 20-26, 21-25, 22-24, 19-29, 20-28, 21-27, 22-26, 23-25, 20-30, 21-29, 22-28, 23-27, 24-26, 21-31, 22-30, 23-29, 24-28, 25-27, 22-32, 23-31, 24-30, 25-29, 26-28, 23-33, 24-32, 25-31, 26-30, 27-29, 24-34, 25-33, 26-32, 27-31, 28-30, 25-35, 26-34, 27-33, 28-32, 29-31, 26-36,27-35, 28-34, 29-33, 30-32, 27-37, 28-36, 29-35, 30-34, 31-33, 28-38, 29-37, 30-36, 31-35, 32-34, 29-39, 30-38, 31-37, 32-36, 33-35, 30-40, 31-39, 32-38, 33-37, 34-36, 31-41, 32-40, 33-39, 34-38, 35-37, 32-42, 33-41, 34-40, 35-39, 36-38, 33-43, 34-42, 35-41, 36-40, 37-39, 34-44, 35-43, 36-42, 37-41, 38-40, 35-45, 36-44, 37-43, 38-42 or 39-41 percent by weight.

### Fatty Materials and Oils

Generally, the term used herein to refer to lipids is “fats.” In the strict sense, fats are solid at room temperature (e.g., butter) and oils, also a type of lipid, are liquid at room temperature. Herein, the term “fat” may refer to both fats and oils (i.e., all lipids). Herein, the term “fats” generally refers to non-animal fats, like fats from plants.

The fats used to make the disclosed food products can be from a variety of sources. In some examples, the sources are non-animal sources (e.g., oils obtained from plants, algae, fungi such as yeast or filamentous fungi, seaweed, bacteria, Archae), including genetically engineered bacteria, algae, archaea or fungi. The fats can be hydrogenated (e.g., a hydrogenated vegetable oil) or non-hydrogenated. Non-limiting examples of plant fats include almond oil, babassu oil, cashew oil, canola oil, cocoa butter, coconut cream, coconut oil, corn oil, cottonseed oil, flax seed oil, mango butter, margarine, olive oil, orrice bran oil, palm oil, palm kernel oil, peanut oil, sesame oil, rapeseed oil, safflower oil, shea butter, soy oil, sunflower oil, walnut oil, wheatgerm oil, combinations thereof, and others.

In some examples, the amount of fats in the food product formulations and/or final food products may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 percent by weight.

In some examples, fats may be included in the food product formulations and/or final food products at amounts that are no more than about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 percent by weight.

In some examples, the amount of fats in the food product formulations and/or final food products may be between about 2-50, 2-40, 2-35, 2-30, 3-40, 3-35, 3-30, 3-25, 3-20, 4-45, 4-40, 4-35, 4-30, 8-40, 8-38, 8-36, 8-34, 8-32, 9-40, 9-38, 9-36, 9-34, 9-32, 9-30, 10-40, 11-38, 12-36, 13-34, 14-32, 14-30, 14-28, 14-26, 16-35, 16-24, 16-22, 18-32, 18-24, 18-22, 19-32, 19-30, 19-28, 19-26, 19-24, 19-22, 19-20, 20-32, 20-30, 20-28, 20-26, 20-24, 20-22, 21-32, 21-30, 21-28, 21-26, 21-24, 21-22, 21-20, 21-18, 22-32, 22-30, 22-28, 22-26, 22-24, 22-22, 22-20, 22-18, 23-30, 23-28, 23-26, 23-24, 24-30, 24-28, 24-26, 25-30, 25-28, 25-26 26-32, 26-30, 26-28 or 27-31 percent by weight.

In some examples, the food bar compositions may contain no lipids or fats.

### Emulsifiers

Herein, emulsions are colloidal solutions with both the dispersed phase and the dispersion medium being liquid. Emulsions can be formed from two liquids that are not miscible. In some examples, an emulsion is an oil (dispersed phase) in water (dispersion medium) emulsion. In unstable emulsions, the liquids will separate in absence of agitation.

Herein, emulsifiers are substances that stabilize emulsions. Generally, emulsifiers used in the disclosed food product formulations and products may be emulsifiers commonly used for oil in water emulsions in food products. In some examples, the emulsifiers used may be lecithins. Lecithins may be from a variety of sources. Generally, the lecithins used herein are from non-animal sources. The lecithins used herein may be from plant sources. In some examples, the lecithins used herein are de-oiled lecithins. Example plant-based lecithins may be from canola, coconut, corn, cottonseed, rapeseed, soy, sunflower and other plants.

In some examples, one or more emulsifiers, including lecithins, may be included in the food product formulations and/or final products. Generally, the emulsifiers are used in amounts that stabilize an emulsion. In some examples, emulsifiers may be present in the formulations/products at about 0.01, 0.02, 0.03, 0.04, 0.05, 0.06, 0.07, 0.08, 0.09, 0.1, 0.12, 0.14, 0.16. 0.18, 0.2, 0.22, 0.24, 0.26, 0.28, 0.3, 0.32, 0.34, 0.36, 0.38. 0.4, 0.42, 0.44, 0.46, 0.48, 0.5, 0.52, 0.54, 0.56, 0.58, 0.6, 0.62, 0.64, 0.66, 0.68, 0.7, 0.8, 0.82, 0.84, 0.86, 0.88, 0.9, 0.92, 0.94, 0.96, 0.98, 1.0, 1.1, 1.2, 1.3, 1.4, 1.5, 1.6, 1.7, 1.8 1.9 or 2.0 weight percent.

In some examples, the food product compositions may contain no emulsifiers, may contain no emulsifiers in addition to other ingredients that may have emulsification activity, or may contain no lecithin emulsifiers.

### Sweetening Agents

Sweetening agents may be used in the food products disclosed herein. In some examples, the sweetening agents may be carbohydrates, sugars for example. In some examples, the sweetening agents may not be carbohydrates. Example sweetening agents for use in foods are known in the art. Some exemplary sweetening agents may include glycerin, erythritol, stevia and others. Individual sweetening agents may be used individually or in combination.

In some examples, the food products disclosed herein may contain no sweetening agents.

### Salt

In some examples, one or more salts are used. In some examples, the salt may be sea salt. In some examples, the salt may be added to the formulation at amounts about 0.0001, 0.0002, 0.0003, 0.0004, 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04 or 0.05 weight percent.

In some examples, the salt may be sodium salt. In some examples, the salt may be calcium or other cationic salts.

In some examples, the salt may have emulsifier activity.

In some examples, the food products disclosed herein may contain no salt.

### Flavoring Agents

Flavors may be used in the food products disclosed herein. Different flavors may be used. An exemplary flavoring agent includes cookie dough flavoring.

In some examples, the disclosed food products may contain no flavoring agents.

### Thickening Agents

Generally, thickening agents refer to substances that increase the viscosity of a liquid. Generally, thickening agents increase viscosity without substantially changing other properties of the liquid. The thickening agents referred to in this application are generally edible thickening agents. In some examples, the thickening agents used herein may dissolve in a liquid as a colloid that forms a cohesive internal structure (e.g., a gel).

Herein, other components of the formulations and/or compositions disclosed herein (e.g., starch, protein) may functionally act to thicken liquid formulations of the food bars described herein. Generally, the substances described in this section are added to the formulations to provide additional thickening.

Many different types of thickening agents may be used. Generally, any thickening agent that is acceptable for use in a food product can be used. Usable thickening agents may include polysaccharides, like starches, vegetable gums, pectin and others. Combinations of thickening agents may be used.

In some examples, the thickening agent may be fecula, including almond flour, arrowroot, cornstarch, katakuri starch, potato starch, sago, tapioca, wheat flour and their starch derivatives. Microbial and vegetable gums used as food thickeners may include alginin, guar gum, locust bean gum, xanthan gum and the like. Proteins used as food thickeners may include certain non-dairy proteins. Sugar polymers include may include agar, carrageenan, carboxymethyl cellulose, pectin and the like.

In some examples, the thickening agent may include a “high acyl gellan gum.” High acyl gellan gum, as used herein, is a polymer comprising various monosaccharides linked together to form a linear primary structure and the gum gels at temperatures of greater than 60° C. The properties of the high acyl gellan gum polymer may vary depending at least in part on its source, how it was processed, and/or the number and type of acyl groups present on the polymer.

Gellan gum is a gel-forming polysaccharide produced by the microbe Sphingomonas elodea. There are several sources of suitable high acyl gellan gums, for example, Ticagel Gellan HS, TIC gums, KELCOGEL High Acyl Gellan Gum, CP Kelco, Gellan Gum LT100 and Modernist Pantry. Gellan polymers typically consist of monosaccharides beta-d-glucose, beta-d-glucuronic acid and alpha-1-rhamnose in approximate molar ratios of 2:1:1 linked together to form a linear primary structure.

In some examples, the thickening agent(s) may be included in the disclosed food products at amounts that are about or at least 0.1, 0.2, 0.3, 0.4, 0.5, 0.6, 0.7, 0.8, 0.9, 1, 1.5, 2.0, 2.5, 3.0, 3.5, 4.0, 4.5 or 5 percent on a weight basis.

In some examples, the thickening agent(s) may be included in the disclosed food products at amounts that are or are between about 0.1-1, 0.1-0.9, 0.1-0.8, 0.1-0.7, 0.1-0.6, 0.1-0.5, 0.1-0.4, 0.1-0.3, 0.1-0.2, 0.2-1, 0.2-0.9, 0.2-0.8, 0.2-0.7, 0.2-0.6, 0.2-0.5, 0.2-0.4, 0.2-0.3, 0.3-1, 0.3-0.9, 0.3-0.8, 0.3-0.7, 0.3-0.6, 0.3-0.5, 0.3-0.4, 0.4-1, 0.4-0.9, 0.4-0.8, 0.4-0.7, 0.4-0.6, 0.4-0.5, 0.5-1, 0.5-0.9, 0.5-0.8, 0.5-0.7, 0.5-0.6, 0.6-1, 0.6-0.9, 0.6-0.8, 0.6-0.7, 0.6-0.6, 0.7-1, 0.7-0.9, 0.7-0.8, 0.8-1, 0.8-0.9 or 0.9-1.0 weight percent.

In some examples, the food products may contain no thickening agents.

### Other Ingredients

The food products disclosed herein may contain inclusions. An example inclusion includes chocolate chips.

The food products disclosed herein may be coated with an exterior layer. Example exterior coatings may include flavoring agents, sweetening agents and the like. Example exterior coatings may include fruit, nuts, grains, seeds, confectionary pieces, protein pieces and the like.

The food products disclosed herein may contain added nutrients. Example nutrients may include vitamin A, vitamin B, Vitamin B2, vitamin B6, vitamin B12, vitamin C, vitamin D, vitamin E, vitamin K, biotin, carnitine, taurine, folic acid, pantothenic acid, niacin, choline, calcium, phosphorus, magnesium, zinc, manganese, copper, sodium, potassium, chloride, iron, selenium, chromium, molybdenum, omega-3 fatty acid and the like.

The food products disclosed herein may include coloring agents.

### Methods of Making the Food Products

The food products disclosed herein may be made using various methods.

In some examples, the food products may be made by blending the components in a mixer. In some cases, all components are mixed at once. In some cases, certain components are mixed sequentially. In some examples, liquid components may be mixed initially and dry components may be added to the liquid components. In some instances, an emulsion if formed. Other ingredients may be added before or after formation of the emulsion. Emulsifiers may or may not be added.

Combining/blending the components may be accomplished using a variety of mixing devices, for example, mechanical agitators and/or pressure jets. The components may also be stirred or mixed by hand. Mixing may continue until the components are distributed substantially evenly throughout the mixture.

Emulsification may occur without additional mechanical energy, or require mechanical energy (e.g., vortexing, homogenization, agitation, sonication, or other suitable mechanical activity).

In some examples, the food product may be made using methods whereby the fat components are heated and, if necessary, melted. Water and emulsifiers are added and an emulsion is formed using stirring, mixing or blending. The starch and protein may be added as the texture of the mixture begins to change. The remaining agents may be added.

In some examples, the food products may be made using methods whereby soluble corn fiber, tapioca syrup, glycerine, cashew better and lecithin are mixed in a mixer. Erythritol, salt and stevia are then added and mixed with the original composition. Once these components are mixed, the protein component may be added, in portions in some examples, to the composition and mixed. Once this is mixed, any inclusions may be added and mixed. Optionally, the composition mass may be removed from the mixer and the inclusions mixed manually. The mass may then be formed into a desired shape. In some examples, the mass is pressed into a slab. The slab is allowed to stand for a time, optionally in a refrigerator or freezer, and then cut into pieces of a desired size and/or calorie content. The pieces may be packaged.

Generally, the process used to make the food products disclosed herein result in a visually homogeneous food product (e.g., food bar). In some instances, the food product may include one or more inclusions which may be visible to human eye. In some instances, an exterior layer may be applied to the food product.

In some examples, the disclosed food products are not baked. In some examples, the process of making the disclosed food products may include a baking step. In some examples, the process for making the food products include one or more extrusion steps. In some examples, the method for making the food products does not include an extrusion step.

### Properties of Food Bars

Generally, the solid, shaped foods (e.g., food bars) disclosed herein, that contain the plant-based, salt-precipitated protein are able to form bars with relatively higher amounts of protein than plant-based protein not prepared by the salt-precipitation method. In some examples, the solid, shaped foods may contain plant-based protein that may not be salt-precipitated but may have certain or certain ranges of particle sizes (e.g., Dx50), aqueous solubilities, solution pHs and/or sodium contents. In some examples, the solid, shaped foods may contain salt-precipitated plant-based protein that may also have certain or certain ranges of particle sizes (e.g., Dx50), aqueous solubilities, solution pHs and/or sodium contents. In some examples, the solid, shaped foods may contain salt-precipitated plant-based protein that may also have certain or certain ranges of particle sizes (e.g., Dx50), aqueous solubilities, solution pHs and sodium contents.

Table 3 in Example 2 of this disclosure shows that protein bars could be made with the salt-precipitated pea protein at levels of about 19 grams of protein per 60 gram bar (Sample A). Using two other commercially-available pea protein preparations, the maximum levels of protein that would result in a formed bar were 16 grams of protein (Sample C) and 15 grams of protein (Sample D) per 60 gram bar (Table 4 in Example 2). Attempts to produce the Sample C and D protein bars with higher levels of the commercially-available pea protein preparations did not result in formed shapes (i.e., the slabs from which bars would be cut, did not hold together).

Additionally, the protein bar with high levels of the salt-precipitated protein (Sample A) had equivalent, if not better taste than the bars containing lower amounts of the non-salt precipitated proteins (Samples C and D), decreasing the need to use flavor maskers.

These data indicated that relatively higher levels of salt-precipitated proteins can be incorporated into and form solid, shaped foods (e.g., food bars) as compared to proteins prepared by other methods. In some examples, the level of salt-precipitated plant protein in protein bars may approach 20 grams per 60 gram high-protein nutrition bars desired for fulfilling protein daily intake for human nutrition without having the known eight food allergens described earlier. These bars have good visual appearance, neutral aroma and good texture.

### Embodiments

The numbered paragraphs below (Nos. 1-51) describe various embodiments of the inventions disclosed herein.

1. A solid, shaped food product, comprising, consisting essentially of or consisting of or at least 15, 16, 17, 18, 19, 20, 21, 22, 23, 24 or 25 grams of non-dairy protein in 60 grams of the food product.

2. The food product of paragraph 1, wherein the non-dairy protein is from a plant source.

3. The food product of one of paragraphs 1 or 2, wherein the non-dairy protein is from a non-allergenic source.

4. The food product of any one of paragraphs 1-3, wherein the non-dairy protein is from a legume source.

5. The food product of any one of paragraphs 1-4, wherein the non-dairy protein is from a pea source.

6. The food product of any one of paragraphs 1-5, wherein the non-dairy protein is from a Pisum L. genus source.

7. The food product of any one of paragraphs 1-6, wherein the non-dairy protein is from Pisum sativum L.

8. The food product of any one of paragraphs 1-7, wherein the non-dairy protein is calcium-precipitated protein.

9. The food product of any one of paragraphs 1-8, wherein the non-dairy protein has an aqueous solubility of less than about 15, 14, 13, 12, 11, 10, 9, 8, 7, 6, 5, 4, 3, 2 or 1% (w/w).

10. The food product of any one of paragraphs 1-9, wherein the non-dairy protein has a solution pH of less than about 7.1, 7.0, 6.9, 6.8, 6.7, 6.6, 6.5, 6.4, 6.3, 6.2, 6.1, 6.0, 5.9, 5.8. 5.7, 5.6 or 5.5.

11. The food product of any one of paragraphs 1-10, wherein the non-dairy protein has a sodium content of less than about 4500, 4000, 3500, 3000, 2500, 2000, 1500, 1000, 900 or 800 ppm.

12. The food product of any one of paragraphs 1-11, wherein the food product includes edible particles held together by one or more binders.

13. The food product of any one of paragraphs 1-12, wherein the food product includes edible particles held together by one or more binders, wherein the binders include carbohydrates and/or fats.

14. The food product of any one of paragraphs 1-13, wherein the food product includes edible particles held together by one or more binders, wherein the edible particles include the non-dairy protein.

15. The food product of any one of paragraphs 1-14, wherein the food product includes edible particles held together by an amount of one or more binders, and wherein the amount of the non-dairy protein in the food product is maximal for the amount of the one or more binders in the food product.

16. The food product of any one of paragraphs 1-15, wherein the food product includes a homogeneous food bar.

17. The food product of any one of paragraphs 1-16, wherein the food product includes inclusions.

18. The food product of any one of paragraphs 1-17, wherein the food product includes an exterior layer.

19. The food product of any one of paragraphs 1-18, wherein the food product includes about or includes no more than about 180, 190, 200, 210, 220, 230 or 250 calories in 60 grams of the food product.

20. The food product of any one of paragraphs 1-19, wherein the food product includes about or includes no more than about 34, 35, 36, 37, 38, 39, 40, 41, 42, 43 or 44 percent by weight of carbohydrate.

21. The food product of any one of paragraphs 1-20, wherein the food product includes about or includes no more than about 0, 1, 2, 3, 4, 5, 6, 7, 8, 9, 10, 11, 12, 13, 14 or 15 percent by weight of fat.

22. The food product of any one of paragraphs 1-20, wherein the food product is not baked.

22. The food product of any one of paragraphs 1-22, wherein the food product is not compressed.

23. A non-baked, shaped food product, comprising, consisting essentially of or consisting of or greater than 16, 17, 18, 19, 20, 21 or 22 grams of refined, salt-precipitated plant protein per 60 grams of the food product.

24. The food product of paragraph 23, wherein the salt includes a calcium salt.

25. The food product of one of paragraphs 23 or 24, wherein the salt-precipitated plant protein is precipitated at an acidic pH.

26. The food product of any one of paragraphs 23-25, wherein the salt-precipitated plant protein is prepared by a process comprising, consisting essentially of or consisting of:

a) obtaining a protein preparation from a plant;

b) washing the protein preparation at a wash pH;

c) extracting the protein preparation at an extraction pH to obtain an aqueous protein solution;

d) separating the aqueous protein solution from non-aqueous components;

e) adding salt and adjusting the aqueous protein solution to a precipitation pH to precipitate protein and obtain a protein precipitate;

f) separating the protein precipitate from non-precipitated components; and

g) washing the protein precipitate to obtain the salt-precipitated protein.

27. The food product of any one of paragraphs 23-26, wherein the salt added is calcium dichloride at a concentration between about 50 mM and about 100 mM.

28. The food product of any one of paragraphs 23-27, wherein the precipitation pH is between about 5 and 6.

29. The food product of any one of paragraphs 23-28, wherein the plant protein has an aqueous solubility of less than about 15, 14, 13, 12, 11, 10, 9, 8, 7, 6, 5, 4, 3, 2 or 1% (w/w).

30. The food product of any one of paragraphs 23-29, wherein the plant protein has a solution pH of less than about 7.1, 7.0, 6.9, 6.8, 6.7, 6.6, 6.5, 6.4, 6.3, 6.2, 6.1, 6.0, 5.9, 5.8. 5.7, 5.6 or 5.5.

31. The food product of any one of paragraphs 23-30, wherein the plant protein has a sodium content of less than about 4500, 4000, 3500, 3000, 2500, 2000, 1500, 1000, 900 or 800 ppm.

32. The food product of any one of paragraphs 23-31, wherein the plant protein is from a legume.

33. The food product of any one of paragraphs 23-32, wherein the plant is pea.

34. The food product of any one of paragraphs 23-33, wherein the food product includes about or includes no more than about 180, 190, 200, 210, 220, 230 or 250 calories in 60 grams of the food product.

35. The food product of any one of paragraphs 23-34, wherein the food product includes about or includes no more than about 34, 35, 36, 37, 38, 39, 40, 41, 42, 43 or 44 percent by weight of carbohydrate.

36. The food product of any one of paragraphs 23-35, wherein the food product includes about or includes no more than about 0, 1, 2, 3, 4, 5, 6, 7, 8, 9, 10, 11, 12, 13, 14 or 15 percent by weight of fat.

37. The food product of any one of paragraphs 23-36, wherein the food product includes a homogeneous food bar.

38. The food product of any one of paragraphs 23-37, wherein the food product includes inclusions.

39. A non-baked, non-dairy protein bar, comprising, consisting essentially of or consisting of or greater than 16, 17, 18, 19, 20, 21 or 22 grams of pea protein per 60 grams of the protein bar.

40. The non-dairy protein bar of paragraph 39, wherein the pea protein is calcium salt-precipitated at an acidic pH.

41. The non-dairy protein bar of one of paragraphs 39 or 40, wherein the pea protein has an aqueous solubility of less than about 15, 14, 13, 12, 11, 10, 9, 8, 7, 6, 5, 4, 3, 2 or 1% (w/w).

42. The non-dairy protein bar of any one of paragraphs 39-41, wherein the pea protein has a solution pH of less than about 7.1, 7.0, 6.9, 6.8, 6.7, 6.6, 6.5, 6.4, 6.3, 6.2, 6.1, 6.0, 5.9, 5.8. 5.7, 5.6 or 5.5.

43. The non-dairy protein bar of any one of paragraphs 39-42, wherein the pea protein has a sodium content of less than about 4500, 4000, 3500, 3000, 2500, 2000, 1500, 1000, 900 or 800 ppm.

44. The non-dairy protein bar of any one of paragraphs 39-43, wherein the protein bar includes about or includes no more than about 180, 190, 200, 210, 220, 230 or 250 calories in 60 grams of the protein bar.

45. The non-dairy protein bar of any one of paragraphs 39-44, wherein the protein bar includes no more than about 34, 35, 36, 37, 38, 39, 40, 41, 42, 43, 44 40, 41, 42, 43, 44, 45, 46, 47, 48, 49 or 50 percent by weight of carbohydrate.

46. The non-dairy protein bar of any one of paragraphs 39-45, wherein the protein bar includes no more than about 0, 1, 2, 3, 4, 5, 6, 7, 8, 9, 10, 11, 12, 13, 14 or 15 percent by weight of fat.

47. The non-dairy protein bar of any one of paragraphs 39-46, wherein the protein bar includes no more than about 3, 4, 5, 6, 7 or 8 percent by weight of sweetening agent.

48. The non-dairy protein bar of any one of paragraphs 39-47, wherein the protein bar includes no more than about 0.1, 0.2, 0.3, 0.4, 0.5, 0.6, 0.7, 0.8, 0.9, 1.0, 1.1, 1.2, 13. 1.4 or 1.5 percent by weight of emulsifier.

49. The non-dairy protein bar of any one of paragraphs 39-48, wherein the protein bar is a homogeneous protein bar.

50. The non-dairy protein bar of any one of paragraphs 39-49, wherein the protein bar includes inclusions.

51. A method for making a food product or protein bar of any one of paragraphs 1-50.

### EXAMPLES

The studies described in these Examples relate to use of three different non-dairy refined protein preparations to make food bars. The refined protein preparations used included a salt-precipitated protein preparation, as described in U.S. Patent Publication No. 2019/0000112 A1, which was used to make the solid, shaped food containing non-dairy protein that are the subject of this patent application. The salt-precipitated protein preparation used in these studies was from yellow pea (Pisum sativum) plants and was precipitated using calcium-based salts.

The refined protein preparations used also included two commercially-available yellow pea (Pisum sativum) protein preparations, as controls. Characterization of the three different non-dairy refined protein preparations is shown in Example 1. Examples 2-4 describe making and characterization of food bar products using the three different protein preparations.

The following Examples are for illustrating various embodiments and are not to be construed as limitations.

### Example 1: Refined Protein Preparations

Three different refined protein preparations were used in these studies. The first, the salt-precipitated protein preparation, is the protein preparation used to make the inventive solid, shaped food containing non-dairy protein that is the subject of this patent application. This protein preparation is from pea plants. This preparation contained 88% protein. Two other commercially-available refined protein preparations, also from pea plants, were used to make solid, shaped food containing non-dairy protein. These two refined protein preparations are referred to herein as Competitor #1 (86% protein) and Competitor #2 (89% protein) refined protein preparations. All three refined protein preparations were in powder form. All three of the refined protein preparations were characterized as described below.

In one set of studies, the particle size distribution (Dx50) for each refined protein preparation was determined and is shown in Table 1. Although not shown, the distribution of particle sizes for each protein preparation was unimodal and roughly symmetrical.

Solubility in water was also determined for each protein preparation and is shown in Table 1. To determine solubility, a 5% protein load was added to 10 ml of water at room temperature and a slurry was made. After 30 minutes, the slurry was centrifuged and the amount of protein in the supernatant was determined using a combustion method. Solubility was calculated.

The pH of water that contained a 10% (w/w) solution of the refined protein preparations was determined and is shown in Table 1. To make this determination, water was supersaturated with the protein preparation at 10% (w/w) and pH of the solution was then determined.

Finally, the amount of sodium, on a ppm basis, was determined for each protein preparation and is shown in Table 1.

TABLE 1
Properties of Refined Proteins Used in Food Bars

| | | Aqueous | Solution | Sodium |
|---|---|---|---|---|
| Protein | Dx50 | Solubility | pH | Content |
| Preparation | (μm) | (% w/w) | (10% w/w) | (ppm) |
| Salt-precipitated | 50 | 2 | 5.5 | 802 |
| protein | | | | |
| Competitor #1 | 114 | 21 | 7.4 | 7530 |
| Competitor #2 | 36 | 15 | 7.1 | 4640 |

The data show that the salt-precipitated protein preparation had a particle size (50 μm) smaller than the particle size of Competitor #1 (114 μm) and larger than the size of Competitor #2 (36 μm). The aqueous solubility of the salt-precipitated protein (2%) was less than the aqueous solubility of both Competitor #1 (21%) and Competitor #2 (15%). The pH of a 10% solution of the salt-precipitated protein (5.5) was less than a 10% solution of both Competitor #1 (7.4) and Competitor #2 (pH 7.1) protein preparations. Also, the sodium content of the salt-precipitated protein (802 ppm) was less than that of both Competitor #1 (7530 ppm) and Competitor #2 (4640 ppm).

### Example 2: Food Bar Ingredients

An example non-dairy protein-containing food bar ingredient formulation is set forth below. Table 2 shows ranges of classes of ingredients used in solid, shaped food (food bars) made using the salt-precipitated protein shown in Table 1 of Example 1 or the competitor proteins. Table 3 shows specific ingredients for two samples of the disclosed solid shaped food that were prepared using the salt-precipitated protein. As shown in Table 3, the Sample A food bar contained 19 g of protein in a 60 g bar. The Sample B food bar contained 16 g of protein in a 60 g bar.

TABLE 2
Classes of Ingredients in Food Bars

| Ingredient | Weight % Range |
|---|---|
| Carbohydrate | 37.0-41.9 |
| Refined protein preparation | 30.6-36.0¹ |
| Fat | 10.0-11.0 |
| Emulsifier | 0.05-0.06 |
| Sweetening, agent | 5.44-6.03 |
| Salt | 0.55-0.60 |
| Flavoring agent | 10.4-10.5 |
| Total | 100 |

¹The refined protein preparation contained 88% actual protein. The indicated amounts of refined protein preparations represent between about 16-19 g protein per 60 g bar.

TABLE 3
Ingredient Compositions of Food Bars Containing Salt-Precipitated
Protein

| | Ingredient Group | Sample A | Sample B |
|---|---|---|---|
| Ingredient | (from Table 2) | Weight % | Weight % |
| Soluble corn fiber | Starch | 20.3 | 22.0 |
| (liquid) | | | |
| Tapioca syrup | Starch | 16.7 | 19.9 |
| Refined pea | Protein | 36.0¹ | 30.6² |
| Cashew butter | Fat | 10.0 | 10.9 |
| Sunflower lecithin | Emulsifier | 0.05 | 0.06 |
| (liquid) | | | |
| Glycerin | Sweetening agent | 3.0 | 2.7 |
| Erythritol | Sweetening agent | 3.0 | 2.7 |
| Stevia | Sweetening agent | 0.03 | 0.04 |
| Sea salt (granular) | Salt | 0.55 | 0.06 |
| Natural cookie | Flavoring agent | 0.75 | 0.74 |
| dough flavor | | | |
| Mini semi-sweet | Flavoring agent | 9.62 | 9.75 |
| chocolate chips | | | |
| (inclusion) | | | |
| | Total | ~100 (100) | ~100 (99.45) |

¹The refined protein contained 88% actual protein. The indicated amount of the refined protein preparation represents 19 g of protein per 60 g bar.
²The refined protein contained 88% actual protein. The indicated amount of the refined protein preparation represents 16 g of protein per 60 g bar.

Table 4 shows specific ingredients for two samples of solid shaped food that were prepared using commercially-available refined pea protein from two competitors (see Example 1). Sample C contained Competitor #1 protein and the food bar contained 16 g of protein in a 60 g bar. Sample D contained Competitor #2 protein and the food bar contained 15 g of protein in a 60 g bar.

TABLE 4
Ingredient Compositions of Food Bars Containing
Competitor Proteins

| | | Sample C | Sample D |
|---|---|---|---|
| | | (Competitor #1 | (Competitor #2 |
| | Ingredient Group | protein) | protein) |
| Ingredient | (from Table 2) | Weight % | Weight % |
| Soluble corn fiber | Starch | 22.3 | 22.5 |
| (liquid) | | | |
| Tapioca syrup | Starch | 18.2 | 20.4 |
| Refined pea | Protein | 30.9¹ | 28.1² |
| protein | | | |
| Cashew butter | Fat | 11.0 | 11.2 |
| Sunflower lecithin | Emulsifier | 0.06 | 0.06 |
| (liquid) | | | |
| Glycerin | Sweetening agent | 2.8 | 2.8 |
| Erythritol | Sweetening agent | 2.8 | 2.8 |
| Stevia | Sweetening agent | 0.04 | 0.04 |
| Sea salt | Salt | 0.61 | 0.62 |
| (granular) | | | |
| Natural cookie | Flavoring agent | 0.75 | 0.76 |
| dough flavor | | | |
| Mini semi-sweet | Flavoring agent | 10.6 | 10.7 |
| chocolate chips | | | |
| (inclusion) | | | |
| | Tota1 | ~100 (100.06) | ~100 (99.98) |

¹The refined protein preparation contained 86% actual protein. The indicated amount of refined protein preparation represents 16 g protein per 60 g bar.
²The refined protein preparation contained 89% actual protein. The indicated amount of refined protein preparation represents 15 g protein per 60 g bar.

Table 5, below, shows the nutritional composition for 60 g of Samples A-D.

TABLE 5
Nutrition Fact Panel (for a 60 g serving size)

| Property | Sample A | Sample B | Sample C | Sample D |
|---|---|---|---|---|
| Calories per 60 g bar | 220 | 210 | 210 | 210 |
| Protein (g) | 19 | 16 | 16 | 15 |
| Total carbohydrate (g) | 27 | 29 | 28 | 31 |
| Carbohydrate as | 8 | 9 | 9 | 9 |
| fiber (g) | | | | |
| Carbohydrate as | 6 | 6 | 6 | 7 |
| sugar (g) | | | | |
| Carbohydrate as | 4 | 3 | 3 | 3 |
| sugar alcohol (g) | | | | |
| Total fat (g) | 7 | 7 | 7 | 7 |
| Saturated fat (g) | 2 | 2 | 2.5 | 2 |
| Trans fat (g) | 0 | 0 | 0 | 0 |
| Cholesterol (mg) | 0 | 0 | 0 | 0 |
| Sodium (mg) | 180 | 190 | 170 | 260 |

### Example 3: Process for Making Food Bars

An example process for making the solid shaped foods containing non-dairy protein (i.e., Samples A, B, C and D) is set forth below:

a) blend components other than protein and inclusions in mixer;

b) blend in protein component;

c) add inclusions and slowly/briefly blend;

d) stop mixer and knead mass to fold inclusions into the mass;

e) remove mass from mixer and add to lightly-oiled zip bag;

f) evenly roll bag until mass is approximately ½″ thick;

g) allow mass to stand overnight (optionally, in refrigerator or freezer);

h) next day, cut mass into 60 g portions (e.g., 1.5″×4″); and

i) package.

### Example 4: Characteristics of Food Bars

Solid, shaped food containing non-diary protein, with the ingredients as shown in Examples 1 and 2 and prepared using the method shown in Example 3, were compared and characterized as shown in Table 6, below. As described in Example 1, Sample A (19 g protein in a 60 g food bar) and Sample B (16 g protein per 60 g food bar) were made using salt-precipitated pea protein. Sample C (16 g protein in a 60 g food bar) and Sample D (15 g protein in a 60 g food bar) were made using two different refined pea protein preparations that are commercially available. Photographs of Samples A, B, C and D are shown in FIGS. 1A, 1B, 1C and 1D, respectively.

TABLE 6
Observations

| Property | Sample A | Sample B | Sample C | Sample D |
|---|---|---|---|---|
| Protein preparation | Salt-precipitated | Salt-precipitated | Competitor #1 | Competitor #2 |
| Amount protein | 19 g/60 g bar | 16 g/60 g bar | 16 g/60 g bar | 15 g/60 g bar |
| Observations | Higher protein | Protein content | Higher protein | Higher protein |
| related to protein in | levels did not | similar to that of | levels did not | levels did not |
| the bars | form into bar | Samples C and | form into bar | form into bar |
| | slabs. | D, but texture of | slabs. | slabs. |
| | | Sample B was | | |
| | | softer and | | |
| | | moister than | | |
| | | Samples C and | | |
| | | D. | | |
| Appearance of | Golden brown, | Golden brown, | Slightly darker | Very light in |
| food bar | slightly matte | glossy surface | than Samples A | color |
| | | | and B | |
| Taste | Neutral with | Neutral with | Very beany, | Clean, neutral, |
| | light beany | light beany | bitter notes, | light vegetal or |
| | notes | notes (less | very savory | nutty taste |
| | | beany than | finish | |
| | | Sample A) | | |
| Aroma | Neutral | Neutral | Neutral | Neutral, nutty |
| Texture | Slight powdery | Moist with | Smooth | Smooth |
| | mouthfeel | pleasant chew, | | |
| | | decreased | | |
| | | perception of | | |
| | | grittiness or | | |
| | | powderiness | | |
| Performance in | Blends easily | Lower protein | Would require | Would require |
| application | with syrup and | load enables | more syrup to | more syrup to |
| | able to achieve | soft matrix and | reach protein | reach protein |
| | higher protein | facilitates | level higher | level higher |
| | load. | incorporation of | than 16 g/60 g | than 15 g/60 g |
| | | inclusions. | bar. | bar. |
| Commercialization | None | Softness could | None | May require |
| considerations | | limit production. | | additional |
| | | | | compression to |
| | | | | achieve similar |
| | | | | density of |
| | | | | Samples A, B |
| | | | | and C. |

The refined, salt-precipitated protein used to make the food bars disclosed herein (Samples A and B), as well as the two different competitor refined proteins used to make Samples C and D, were from pea. These studies showed that the salt-precipitated pea protein used to make Samples A and B was the only refined protein of the three pea protein preparations that could be used at amounts greater than 16 g per 60 g food bar. In Sample A, the disclosed refined protein was present at 19 g per 60 g food bar. Neither the refined proteins used to make Sample C or Sample D were able to form bars above 16 g or 15 g per 60 g bar, respectively, with the recipe that was used. Additionally, the Sample B food bar, which had similar amounts of protein as Samples C and D, was softer and more moist than the Sample C and D food bars.

Regarding taste, it was found that the Sample A and B food bars, which used the salt-precipitated pea protein, had a more neutral and clean overall taste. The taste of the Sample A and B food bars was less beany, bitter, nutty or vegetal as compared to the Sample C and D food bars. The food bars made with the calcium-precipitated pea protein (Samples A and B) were more neutral in flavor and lower in bitter aftertaste than the food bars made with competitor pea proteins (Samples C and D). Therefore, even though flavoring agents were used in the bars made here (e.g., natural cookie dough flavor), there is less need for use of flavoring agents or flavor maskers when calcium-precipitated pea protein is used in the bars.

1. A solid, shaped food product, comprising at least 17 grams of non-dairy protein in 60 grams of the food product;
wherein the non-dairy protein has a solution pH selected from the group consisting of about 6.2, 6.1, 6.0, 5.9, 5.8, 5.7, 5.6, 5.5, 5.4, 5.3, 5.2, 5.1, 5.0, 4.9 and 4.8
in water supersaturated with the non-dairy protein at 10% (w/w);
wherein the non-dairy protein is from an alkaline-extracted source; and
wherein the food product includes no more than about 20% (w/w) of syrup.

2. The food product of claim 1, wherein the non-dairy protein is from a non-allergenic source.

3. The food product of claim 1, wherein the non-dairy protein is from a plant source.

4. The food product of claim 1, wherein the non-dairy protein is from a pea source.

5. The food product of claim 1, wherein the non-dairy protein is calcium-precipitated protein.

6. The food product of claim 5, wherein the non-dairy protein is precipitated at an acidic pH.

7. The food product of claim 1, wherein the non-dairy protein has an aqueous solubility of less than about 15% (w/w) in water at room temperature.

8. (canceled)

9. The food product of claim 1, wherein the non-dairy protein has a sodium content of less than about 4500 ppm.

10. The food product of claim 1, wherein the food product includes a homogeneous food bar.

11. The food product of claim 1, wherein the food product includes inclusions.

12. The food product of claim 1, wherein the food product includes no more than about 230 calories in 60 grams of the food product.

13. The food product of claim 1, wherein the food product is not baked.

14. The food product of claim 1, wherein the non-dairy protein is prepared by a process comprising:
a) obtaining a protein preparation from a plant;
b) washing the protein preparation at a wash pH;
c) extracting the protein preparation at an extraction pH to obtain an aqueous protein solution, wherein the extraction pH is alkaline;
d) separating the aqueous protein solution from non-aqueous components;
e) adding salt and adjusting the aqueous protein solution to a precipitation pH to precipitate protein and obtain a protein precipitate;
f) separating the protein precipitate from non-precipitated components; and
g) washing the protein precipitate to obtain the non-dairy protein.

15. A method for making a solid, shaped food product that includes at least 17 grams of non-dairy protein in 60 grams of the food product, comprising:
a) preparing the non-dairy protein by:
i) obtaining a protein preparation from a plant;
ii) washing the protein preparation at a wash pH;
iii) extracting the protein preparation at an extraction pH to obtain an aqueous protein solution, wherein the extraction pH is alkaline;
iv) separating the aqueous protein solution from non-aqueous components;
v) adding salt and adjusting the aqueous protein solution to a precipitation pH to precipitate protein and obtain a protein precipitate;
vi) separating the protein precipitate from non-precipitated components; and
vii) washing the protein precipitate to obtain the non-dairy protein;
b) combining and mixing the non-dairy protein and other ingredients; and
c) forming the combined and mixed non-dairy protein and the other ingredients into a slab;
wherein the food product includes no more than about 20% (w/w) of syrup.

16. The method of claim 15, wherein the non-dairy protein has a solution pH selected from the group consisting of about 6.2, 6.1, 6.0, 5.9, 5.8, 5.7, 5.6, 5.5, 5.4, 5.3, 5.2, 5.1, 5.0, 4.9 and 4.8 in water supersaturated with the non-dairy protein at 10% (w/w).

17. The method of claim 1, wherein the syrup includes tapioca syrup.

18. The method of claim 1, wherein the food product includes no more than about 50% (w/w) carbohydrates.

19. The method of claim 1, wherein the food product includes between about 18-22% (w/w) soluble fiber.
